(19) United States
(12) Patent Application Publication
(10) Pub. No.: US 2003/0186046 A1
(43) Pub. Date: Oct. 2, 2003

(54) Repetitive tearing/sticking foaming printed adhesive floor tile

(76) Inventor: Chen-Chi Mao, Taipei (TW)

Correspondence Address: BACON & THOMAS, PLLC, 625 SLATERS LANE, FOURTH FLOOR, ALEXANDRIA, VA, 22314

(21) Appl. No.: 10/107,268

(22) Filed: Mar. 28, 2002

(51) Int. Cl. B32B 3/26; B32B 9/00; B32B 7/12; B32B 15/04

(52) U.S. Cl. 428/343; 428/354; 428/304.4; 428/318.4

(57) ABSTRACT

A type of floor tile, which comprises a printed adhesive floor tile layer on the top layer, a soft foaming layer in the middle layer and a non-adhesive pressure-sensing rubber layer at the bottom layer, in which the area of the soft foaming layer is equal to or slightly smaller than the printed adhesive floor tile layer on the top and with the thickness between 1 mm˜4 mm; therefore, the floor tile can provide comfortable feeling during stepping on and can be repetitively torn and stuck, and will have no glue silk during tearing and no glue dirt on the ground after tearing.

### BACKGROUND OF THE INVENTION

1. Field of the Invention

The invention relates to a type of floor tile which comprising a soft foaming layer at the bottom of the printed adhesive floor tile, and coating with non-adhesive pressure-sensing rubber on the bottom surface of the soft foaming layer.

2. Description of the Prior Art

The current structure of plastic printed adhesive floor tile on the market (as shown in FIG. 1) comprises a printed layer 11 and a liner layer 12 at the bottom. The printed layer 11 is mostly a thin film layer with printed pattern, and the liner layer 12 is usually made of PVC material. For the characteristics of the floor tile, the ground paved with such floor tiles can provide softer stepping feeling than the concrete tile but harder than the carpet, and the noise level generated during walking on is between the other two. For a long time, the plastic floor tile provides low prices and convenient paving operation and without the dirty property as in the carpet, so that it becomes the best decoration material in place of the other paving material. Nevertheless, from the application history of the plastic floor tile, the paved ground was still too hard that will cause uncomfortable feeling during stepping on and without cushion effect, and is liable to occur larger walking noise. Another disadvantage of the plastic floor tile is that the self-adhesive floor tile, no matter with spraying glue on the ground or spraying glue on the bottom of the floor tile, usually needs tedious work to get rid of the hard glue dirt attached on the ground while replacing with new tiles.

### SUMMARY OF THE INVENTION

The present invention provides an improved structure for floor tiles, which can improve the hard feeling during stepping on and the inconvenience of tearing after sticking. The invention comprises a printed adhesive floor tile on the top layer, a soft foaming layer on the middle layer and a non-adhesive pressure-sensing rubber coating at the bottom, wherein the thickness of the soft foaming layer is between 1 mm˜4 mm and the area of the same is slightly smaller than or equal to the area of the printed adhesive floor tile. In such a floor tile structure, the printed adhesive floor tile layer can provide the strong, bright characteristics as the conventional plastic floor tile, and the soft foaming layer can absorb the impact force during stepping on to provide a soft and comfortable stepping feeling. Furthermore, the non-adhesive pressure-sensing rubber at the bottom can not only provide the operation for repetitive tearing and sticking of the floor tiles, but also prevent the glue spilling effect for the self-adhesive hot melted glue after the sticking, and also without any glue silk and residual glue dirt phenomenon after tearing. Therefore, such type of floor tile can effectively solve the existed various problems in the conventional plastic floor tiles.

### BRIEF DESCRIPTION OF THE DRAWINGS

FIG. 1 is the cross-sectional view of the conventional plastic floor tile;

FIG. 2 is the cross-sectional structure diagram of the present invention.

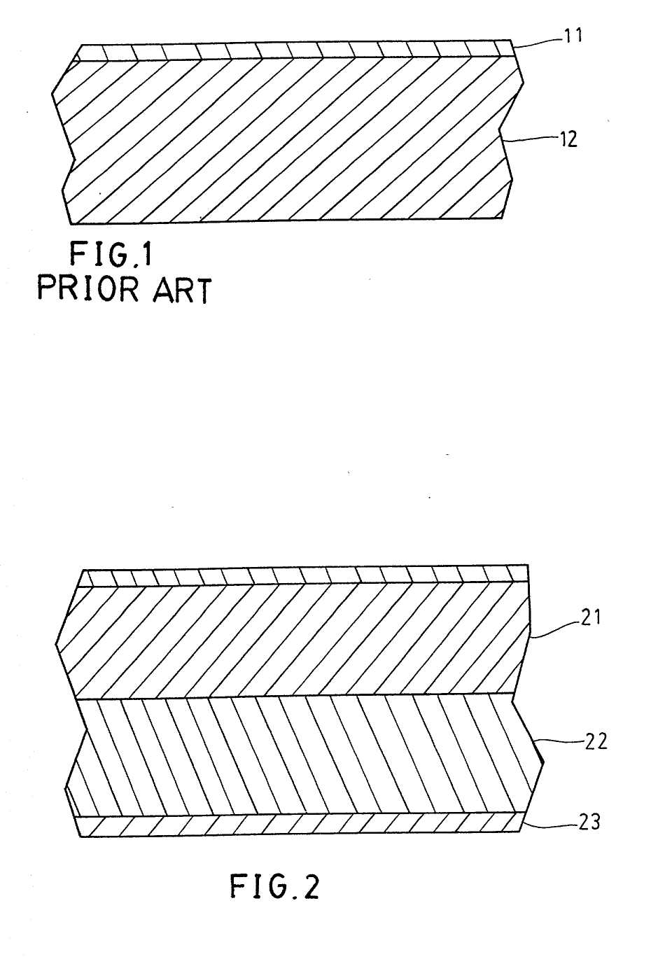

### DESCRIPTION OF THE PREFERRED EMBODIMENTS

The structure in the preferred embodiment according to the present invention is shown in FIG. 2, which comprises a printed adhesive floor tile 21 on the top layer, a soft form 22 in the middle layer, and a non-adhesive pressure-sensing rubber 23 at the bottom layer, wherein the printed adhesive floor tile 21 is a structure as the conventional printed plastic floor tile. The soft form 22 is a kind of softer material such as the foaming material or the liner layer made of non-woven fabric that mainly provides the soft stepping feeling of the printed adhesive floor tile, in which the thickness is preferred between 1 mm˜4 mm and the area is equal to or slightly smaller than the printed adhesive floor tile 21 on the top. The bottom of the soft form 22 is coated with a non-adhesive pressure-sensing rubber 23 which can be in the manner of totally coated or partially coated, with which to provide the repetitive tearing/sticking for the plastic floor tile and without the glue silk or glue spilling phenomenon during tearing/sticking.

What is claimed is:

1. A repetitive tearing/sticking foaming printed adhesive floor tile, which comprises a printed adhesive floor tile on the top layer, a liner layer on the middle layer and a rubber layer at the bottom, is characterized that:
the middle layer is a kind of soft form, with the thickness between 1 mm˜4 mm and the area being equal to or slightly smaller than the printed adhesive floor tile on the top;
the rubber layer at the bottom is a non-adhesive pressure-sensing rubber which can be applied in the manner of totally or partially glue coating.

2. A foaming printed adhesive floor tile according to claim 1, wherein the middle soft form is a kind of foaming material or non-woven fabric.
